(19) United States
(12) Patent Application Publication
(10) Pub. No.: US 2021/0346908 A1
(43) Pub. Date: Nov. 11, 2021

(54) Apparatus for Depositing Paint Globules to Overhead Surfaces and Method of Using Same

(71) Applicant: Marinus Bernard Bosma, Tipp City, OH (US)

(72) Inventor: Marinus Bernard Bosma, Tipp City, OH (US)

(73) Assignee: Marinus B. (Ben) Bosma, Tipp City, OH (US)

(21) Appl. No.: 17/241,131

(22) Filed: Apr. 27, 2021

(51) Int. Cl. B05C 17/005; B05C 11/10

(52) U.S. Cl. CPC B05C 17/00516; B05C 11/1039; B05C 11/1028; B05C 17/00513

(57) ABSTRACT

A paint dispenser which, when pushed against a surface, releases a metered amount of phosphorescent paint or fluorescent paint in sufficient quantity to simulate a single star when room lighting is turned off. The pump is mounted to a common handle by screw-on means so that an operator's reach is extended from normal standing height to a height sufficient to contact the ceiling with the depositor.

### FIELD OF THE INVENTION

The present invention relates to a paint applicator and, more particularly, to a handle mounted depositor to apply small paint globules to ceilings. The depositor is actuated by pressing it to a surface where a metered and variable amount of paint is deposited on the surface. In its most popular embodiment, the material applied is a glow-in-the-dark paint which when applied in a random pattern on a ceiling gives the illusion of nighttime stars overhead when the lights are turned off. A second embodiment would be that the material applied is a fluorescent paint that gives the illusion of nighttime stars overhead when the globules are illuminated by ultraviolet lighting sometimes called black lights.

### BACKGROUND OF THE INVENTION

To apply glow-in-the-dark or fluorescent drops of paint on a ceiling to simulate nighttime stars when the room is darkened.

Applying glow-in-the-dark stars is an expensive and labor-intensive task. Typically, the stars are self-adhesive and come on die-cut sheets where the user removes an individual star and sticks it to the ceiling by hand. The process requires the person to be near the ceiling by ladder means. If the entire ceiling is to be covered in stars the floor must be free of obstacles for the ladder. Additionally, to create a realistic night sky illusion, the entire ceiling must be covered with enough stars to replicate a typical starry night. This usually means applying thousands of stickers which is difficult, exhausting, and dangerous work if the ceiling is high or elevating means are not available.

Plastic, stick-on stars don't have the lasting power of direct glow-in-the-dark paint because they contain a lot of plastic relative to pigment to be stable. This requires them to be heavier and larger than would be required if the paint were directly applied to the ceiling. Plastic stick-on stars can only contain glow-in-the-dark paint compatible with the plastic to which they are bound. Plastic, stick-on stars are expensive when a dense star field is required because the plastic matrix must be added to the paint in the matrix. Applying stick-on stars is time consuming and the stars are visible on the ceiling when the room is lighted. It is therefore an object of the invention to deposit paint globules on ceilings.

It is another object of the invention to extend the reach of the user to allow depositing of paint globules while standing on the floor.

It is another object of the invention to deposit enough globules in a single applicator to convincingly create a simulated star field.

It is another object of the invention to deposit glow-in-the-dark paint to simulate stars on a ceiling.

It is another object of the invention to deposit fluorescent paint to simulate stars on a ceiling.

It is another object of the invention to deposit glow-in-the-dark paint to simulate stars on a ceiling with the lights out so that the effect is immediately apparent.

### SUMMARY OF THE INVENTION

In accordance with the present invention, there is provided a paint depositor that deposits a drop of glow-in-the-dark or fluorescent paint in a hemispherical-shaped globule that when combined with other similarly deposited globules simulates a starry sky when, after the glow-in-the-dark paint has been charged or the fluorescent paint activated, and the lights are turned off. Additionally, the paint depositor can be attached to a handle such as a standard mop or broom handle so that it can be operated by a user while standing on the floor. The depositor deposits the paint in a way that leaves the paint in a hemisphere so that the globule can be seen at an angle to the ceiling rather than just from below further enhancing the starry sky simulation from viewing positions other than directly below the globules.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a user depositing paint globules on a ceiling;

FIG. 2 is a sequential view of an of a paint depositor in use showing the sequence of depositing a paint globule to a ceiling;

FIG. 3 is a section view of a paint depositor;

FIG. 4 is a front view of a paint depositor; and

FIG. 5 is a perspective view of a paint depositor.

For purposes of clarity and brevity, like elements and components will bear the same designations and numbering throughout.

### DESCRIPTION OF THE PREFERRED EMBODIMENT

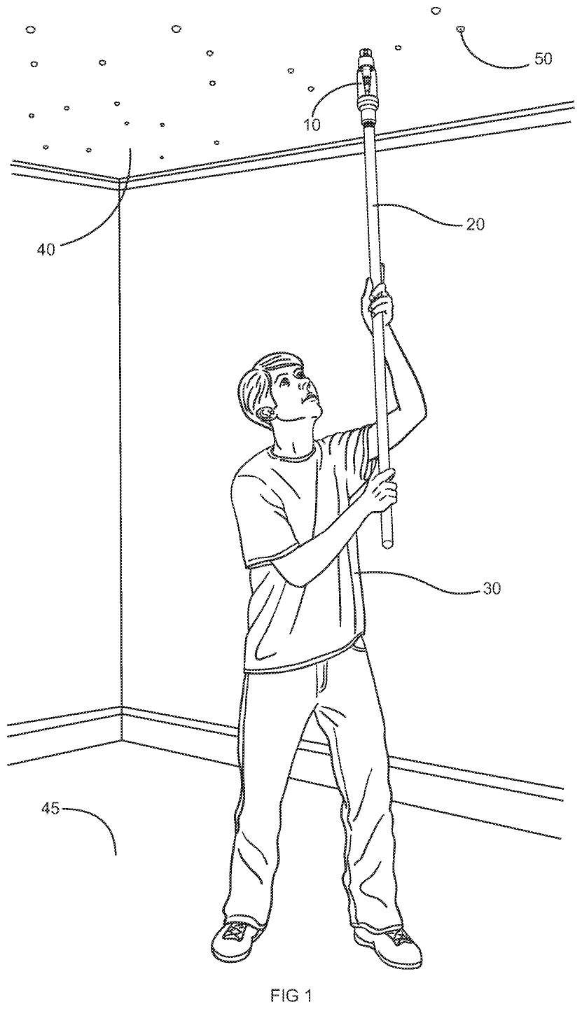

FIG. 1 is a perspective view of a user 30 standing on the floor 45 holding a mop or similar style handle 20 to which a paint depositor 10 is attached. The user 30 is depositing a hemispherical paint-globule 50 by pushing upwardly on the depositor which causes paint 130 to flow out of the paint depositor 10.

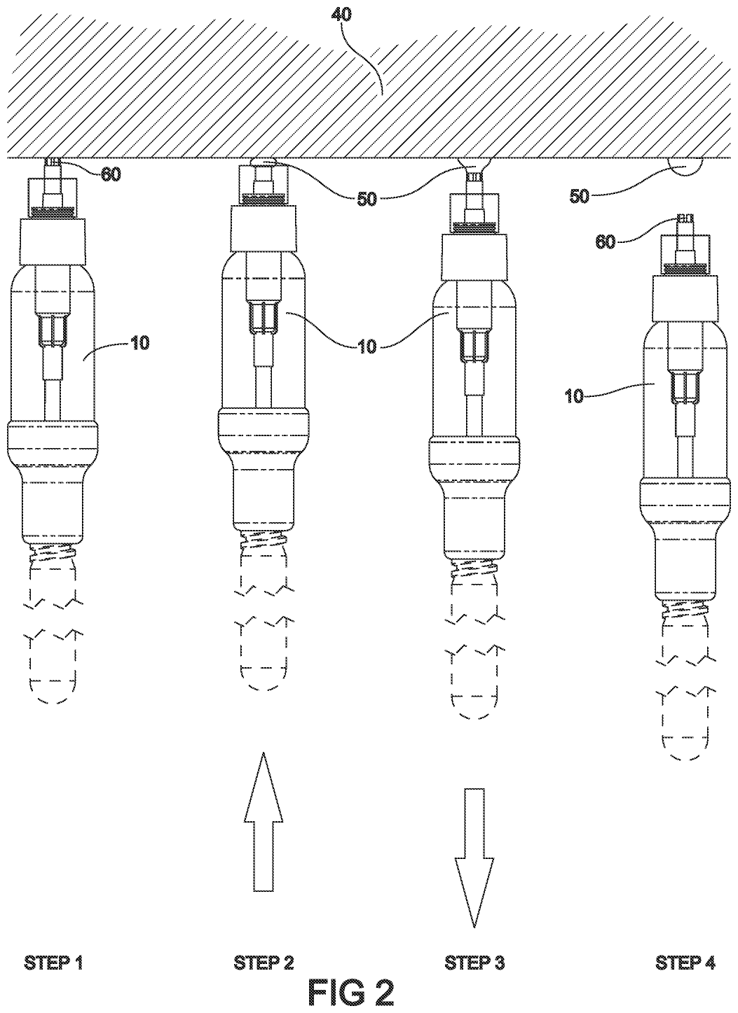

FIG. 2 shows how the paint depositor 10 deposits a paint-globule 50 on a ceiling 40. In step one the user 30 presses the nozzle 60 upwardly against the ceiling 40. In step 2 the user 30 compresses the nozzle 60 leaving behind a paint 130-drop. In step 3 the user 30 releases the paint depositor 10 leaving the paint-globule 50 on the ceiling 40. In step 4 the nozzle 60 is restored to the extended position and the paint-globule 50 assumes a hemispherical shape.

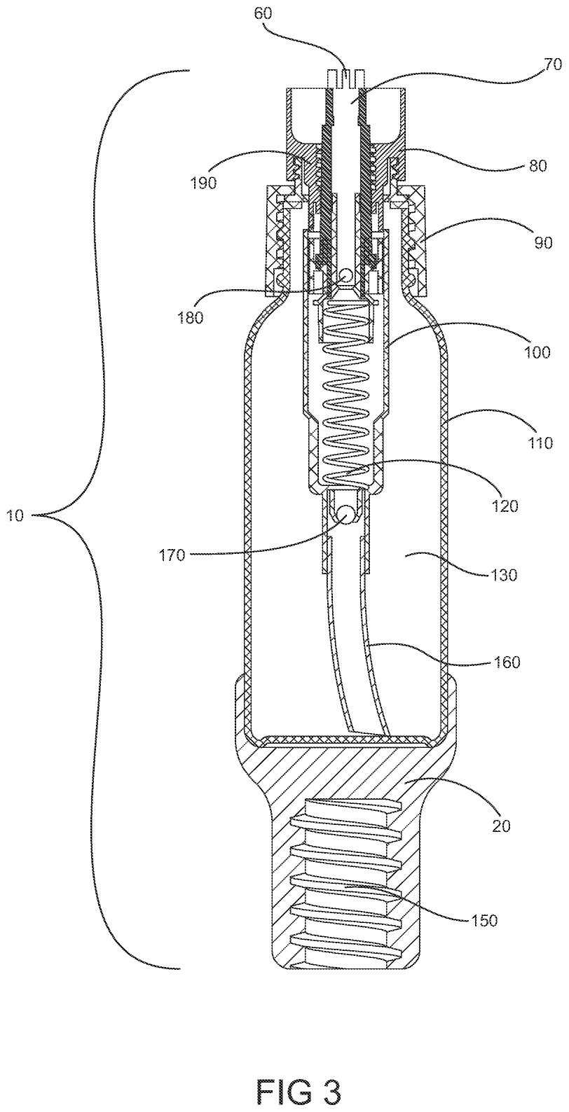

FIG. 3 is a section view of the paint depositor 10 showing the slotted nozzle 60 on the end of the nozzle channel 70. The nozzle channel 70 slides inside the recovery cup 80. The recovery cup 80 has a return duct 190. Inside the nozzle channel 70 is a secondary check valve 180. Below the secondary check valve 180 is a spring 120 which pushes against the nozzle channel 70 at the top and reservoir 100 at the bottom. At the bottom of the reservoir 100 is a tube 160 which extends to the bottom of the bottle 110. At the top of the tube 160 is a check valve 170. The reservoir 100, tube 160, spring 120 and check valve 170 are submerged in the paint 130. The bottle 110 is attached to an adapter 140 which has a standard mop or similar style handle 20 internal thread 150.

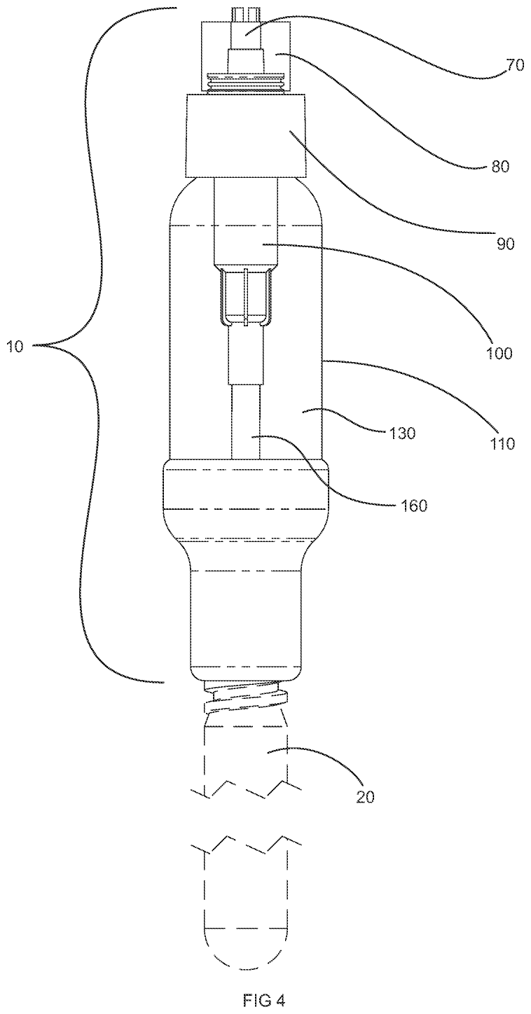

FIG. 4 is a front view of a paint depositor 10 with a nozzle channel 70, recovery cup 80, cap 90, reservoir 100, bottle 110, paint 130, tube 160 and optional mop or similar style handle 20.

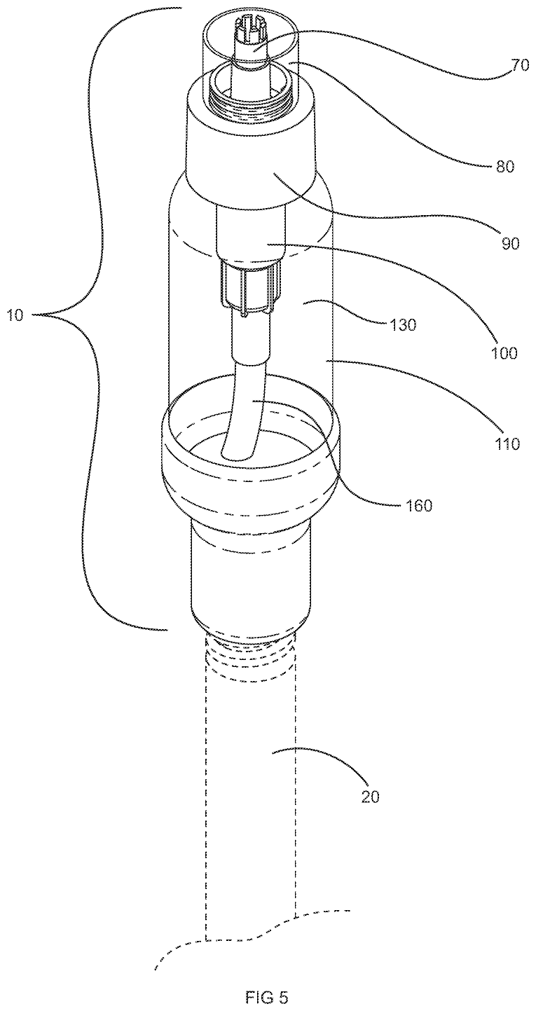

FIG. 5 is a perspective view of a paint depositor 10 with a nozzle channel 70, recovery cup 80, cap 90, reservoir 100, bottle 110, paint 130, tube 160 and optional mop or similar style handle 20.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims:

1. An apparatus for depositing paint globules to overhead surfaces and method for applying paint droplets to ceilings to simulate stars in the sky, comprising:
means for depositing paint globules;
means for pushing the paint depositor against the ceiling;
means for storing paint;
means for creating the illusion of a star, permanently adhered to a ceiling, and upwardly deposits to said ceiling for depositing paint globules;
means for directing paint to nozzle;
means for capturing excess paint;
means for securing pump to bottle;
means for returning pump to first position;
means for transporting paint into pump;
means for attaching depositor to handle;
means for affixing depositor to mop or similar style handle;
means for keeping paint in reservoir;
means for keeping paint in nozzle channel; and
means for draining excess paint;

2. The apparatus for depositing paint globules to overhead surfaces and method of using same in accordance with claim 1, wherein said means for depositing paint globules comprises a portable paint depositor.

3. The apparatus for depositing paint globules to overhead surfaces and method of using same in accordance with claim 1, wherein said means for pushing the paint depositor against the ceiling is by a user.

4. The apparatus for depositing paint globules to overhead surfaces and method of using same in accordance with claim 1, wherein said means for creating the illusion of a star comprises a glow in the dark, paint paint-globule.

5. An apparatus for depositing paint globules to overhead surfaces and method of using same for applying paint droplets to ceilings to simulate stars in the sky, comprising:
a portable paint depositor, for depositing paint globules;
a glow in the dark, paint paint-globule, for creating the illusion of a star, permanently adhered to said ceilings, and upwardly deposits to said ceiling;
a cross-slotted nozzle, for depositing paint;
a nozzle channel, for directing paint to nozzle;
a vertically oriented recovery cup, for capturing excess paint;
a twist on cap, for securing pump to bottle;
a reservoir, for holding paint;
a spring, for returning pump to first position;
a glow in the dark, fluorescent paint, for creating globules;
a suction, flexible tube, for drawing paint into pump;
a threaded adapter, for attaching depositor to handle;
a standard mop or similar style handle internal thread, for affixing depositor to mop or similar style handle;
a ball check valve, for keeping paint in reservoir;
a ball secondary check valve, for keeping paint in nozzle channel; and
a return duct, for draining recovery cup.
